(19) United States
(12) Patent Application Publication
(10) Pub. No.: US 2026/0251785 A1
(43) Pub. Date: Aug. 27, 2026

(54) COMPONENT FOR A VEHICLE AND RADIATOR GRILLE HAVING SUCH A COMPONENT

(71) Applicant: MERCEDES-BENZ GROUP AG, Stuttgart (DE)

(72) Inventors: Fritz WAZULA, Calw (DE); Harald TATTKO, Gaertringen (DE); Jens HUMPENOEDER, Ulm (DE); Peter SCHMITZ, Aidlingen (DE); Marius SILLMANN, Böblingen (DE)

(21) Appl. No.: 19/160,299

(22) PCT Filed: Jan. 23, 2024
(86) PCT No.: PCT/EP2024/051545

§ 371 Date: Aug. 27, 2025

(30) Foreign Application Priority Data
Feb. 28, 2023 (DE) 10 2023 000 719.6

(51) Int. Cl. G01S 13/931; B60K 11/08; B60R 11/00; B60R 11/04; B60R 13/04; F21V 8/00

(52) U.S. Cl. CPC G01S 13/931; B60R 13/04; G02B 6/0045; B60K 11/08; B60R 2011/004; B60R 2011/0045; B60R 11/04; G01S 2013/93271

(57) ABSTRACT

A vehicle component has a visible element with a decorative region that is at least partially permeable to radar and light rays. The component has a carrier element that is at least partially permeable to radar and light rays. A heating element that is at least partially permeable to radar and light rays is arranged to heat the decorative region. A light guide device that is at least partially permeable to radar rays and light rays illuminates the decorative region. A radar camera for traffic monitoring transmits radar rays through the vehicle component.

### BACKGROUND AND SUMMARY OF THE INVENTION

Exemplary embodiments of the invention relate to a component for a vehicle, and in particular to a radiator grille for a vehicle having such a component.

A generic component for a vehicle is known from DE 10 2016 007 119 A1.

A radome having a radio-transmitting substrate is known from WO 2021/018422 A1, which has a first surface and a second surface and a radio-transmitting coating on the first surface.

An apparatus for lighting a vehicle using light-conducting plates containing a fluorescent substance is known from U.S. Pat. No. 5,709,453 A.

A radome having a front side and a back side and at least one coupling-in structure for coupling light into the radome and having a heating device is known from DE 10 2015 004 204 A1.

DE 10 2014 002 438 A1, for example, describes a component for a vehicle having a visible element with a decorative region, which has a decorative design visible from the surroundings, and through which radar rays of a radar camera can pass through. DE 10 2014 002 438 A1 furthermore proposes a heating element, with the use of which the decorative region can be heated. Therefore, any fogging that occurs on the decorative region, for example icing or moisture condensation, can be prevented or eliminated.

Exemplary embodiments of the invention are directed to an embodiment for a component that is improved in comparison to the known component, or at least another embodiment. In particular, a radiator grille for a vehicle having such a component is to be specified.

The fundamental idea of the invention is to additionally illuminate or backlight such a component.

For this purpose, a component for a vehicle, in particular a vehicle designed for partially autonomous driving, is proposed, which has a visible element having a decorative region. The decorative region is designed to be at least partially or completely permeable for radar rays and light rays. Furthermore, it has a visible side and a back side facing away from the visible side. Expediently, the decorative region can be equipped with or form such a decorative design visible from the surroundings, for example it may be a three-dimensional design, a pattern or similar aesthetic artistic elements.

The component according to the invention furthermore has a carrier element designed to be at least partially or completely permeable for radar rays and light rays. The carrier element in turn is arranged on the back side of the decorative region and has a heating element, for example opposite the decorative region, which is designed to be at least partially or completely permeable for radar rays and light rays and is set up to heat the decorative region. It is essential that the component according to the invention is equipped with a light guide device, designed to be at least partially or completely permeable for radar rays and light rays, for illuminating or backlighting the decorative region and/or the visible element. The light guide device can lie opposite the heating element, for example. Furthermore, it can be provided that light rays provided, for example by a light source of the component or the vehicle, can be laterally coupled into the component or the light guide device using the light guide device. Furthermore, it is provided that the light guide device is arranged on a carrier back side of the carrier element facing away from the decorative region and is set up to transmit light rays to the decorative region. Furthermore, it is essential that the component according to the invention is equipped with a radar camera for monitoring traffic and in particular for distance measurement, which is arranged on a back side of the light guide device facing away from the carrier element and is set up to transmit radar rays to the decorative region.

Therefore, a component through which light rays and radar rays can pass is specified. The characteristic that radar rays are able to pass through is used for traffic monitoring and in particular for distance measurement, while the additional characteristic that light rays are also able to pass through enables the component to be illuminated or backlit, which provides a visually pleasant effect for a user of the component. The decorative region of the visible element can be heated using the heating element, so that during operation of the vehicle any condensation fogging, for example icing or moisture condensation, can be prevented or eliminated on the visible side of the decorative region. This has the advantage that light rays and radar rays can permeate unhindered through the decorative region even in difficult weather conditions, meaning that the component according to the invention can also be reliably operated.

The invention understands “light rays” to expediently mean electromagnetic radiation, which has a wavelength range visible to the human eye.

Furthermore, the invention understands “radar rays” expediently to mean electromagnetic radiation, the wavelength range of which is in the radio-frequency range.

Expediently, it is provided that the light guide device and/or the carrier element form a cover for the radar camera. In this case, it is expedient when the back side of the light guide device and/or the carrier back side of the carrier element at least partially or completely covers a diaphragm opening of a diaphragm of the radar camera orientated towards the decorative region. Therefore, the radar camera can be protected from damaging environmental influences, such as moisture or solar radiation.

According to the invention, it is provided that the light guide device has a central light guide element, designed to be permeable for radar rays and light rays, by which light rays can expediently be laterally coupled in, and a light guide element for guiding light rays from a light source to the central light guide element. The central light guide element can be designed off-tool. This means it can be designed so that it is produced in a single production step, without the need for a further processing or assembly step. The central light guide element can, in particular, be produced as an injection molding element in an injection molding process. The central light guide element can be arranged on the component during the production of the component in an injection molding process. This means that the central light guide element can be injection-molded onto the carrier element and/or onto the radar camera.

Furthermore, in particular it can be provided that the central light guide element is supported, on the one hand, on the diaphragm of the radar camera and/or, on the other hand, on the carrier element and covers the diaphragm opening.

According to the invention, it is provided that the light guide element has a ring-shaped design, wherein it is optionally supported on a light coupling-in surface of the central light guide element for coupling light rays into the central light guide element. In this case, it can be provided that the light coupling-in surface of the central light guide element and/or the ring-shaped light guide element runs outside an optical path formed by the radar rays and/or the light rays and encloses the same. The ring-shaped light guide element can, in particular, be designed in a circular or elliptical shape. It is also conceivable that it has the shape of a triangular, rectangular or polygonal ring element. The ring-shaped light guide element is expediently equipped with a mating light coupling-in surface, which is arranged on the light coupling-in surface of the central light guide element so that light rays coupled into the light guide element can be effectively passed from the light guide element into the central light guide element. The light coupling-in surface of the central light guide element is expediently matched in terms of design to the light guide element or the mating light coupling-in surface. The light coupling-in surface of the central light guide element can be polished and/or designed on the tool, in order to improve light coupling of light rays using the light guide element. The same can of course also be provided for the mating light coupling-in surface.

It is expedient when the component or a vehicle equipped with the component has at least one light source for providing light rays to the component. For example, light rays can be coupled into the light guide device, preferably into the light guide element of the light guide device, using the light source.

According to a first embodiment of the invention it is provided that the radar camera has a diaphragm having a diaphragm opening facing towards the decorative region, wherein the radar camera is set up to transmit radar rays through the diaphragm opening to the decorative region. Furthermore, the ring-shaped light guide element has an inner diameter, which is equal to or greater than a diaphragm diameter of the diaphragm opening. Therefore, it is ensured that the ring-shaped light guide element does not cover the diaphragm opening in the mounted state and radar rays can reach through to the decorative region unhindered by the light guide element from the radar camera through the diaphragm opening and the central light guide element. Expediently, the ring-shaped light guide element and the, for example, circular-shaped diaphragm opening are arranged coaxially/concentrically to each other.

The radar camera can be formed by a conventional traffic monitoring radar camera.

According to a second embodiment according to the invention, it is provided that the light coupling-in surface of the central light guide element tapers in the form of a funnel towards the decorative region or towards the radar camera. The light guide element is supported on a light coupling-in surface of the central light guide element for coupling light rays into the central light guide element. Therefore, the light coupling-in surface of the central light guide element is designed in the form of a funnel, wherein an imaginary funnel tip points either to the decorative region or to the radar camera. Therefore, it is relatively easy to couple light into the light guide device or into the central light guide element in a space-saving manner. In particular, therefore, a space-saving lateral coupling of light rays into the central light guide element or into the light guide device is possible.

Further expediently, it is provided that the light guide device or a light guide element of the light guide device and a central light guide element of the light guide device form a prefabricated assembly. This assembly can be used as an insert as an intermediate product when producing the component or a radiator grille having such a component and can be fixed to the carrier element, in particular in an injection molding process. The production of a component forming the subject-matter of the invention can be simplified, in particular accelerated, using a corresponding intermediate product. Additionally, it is possible that the intermediate product is prefabricated and is kept in storage so that it can be used later during production of the component.

Expediently, it is provided that the heating element is realized as a heating foil and preferably by an electrically operable heating foil. Alternatively or additionally, the heating element can be arranged on the back side of the decorative region. A corresponding heating element that can be penetrated by radiation can be provided cost-effectively and in large quantities, so that the component forming the subject-matter of the invention can be produced cost-effectively overall. The arrangement of the heating element on the back side of the decorative region has the advantage that heat provided by the heating element can be provided to prevent or eliminate fogging without a notable time delay and directly on the decorative region. Fundamentally, it is of course also conceivable that the heating element is embedded centrally and completely in the carrier element or is arranged on the carrier back side of the carrier element.

Further expediently, it is provided that the carrier element is produced from a plastic material or has the same. The plastic material used can, in particular, be polycarbonate (abbr. PC). Therefore, an embodiment that can be produced cost-effectively can be specified for the carrier element.

Further expediently, it is provided that the visible element and/or the decorative region has or forms a flat layer arrangement, which has a flat outer layer, for example made from a polyurethane coating (abbr. PU), having or forming a visible side, a flat lacquer layer arranged on the same and a flat chrome layer arranged on the lacquer layer, which has or forms the back side of the decorative region. The lacquer layer can fundamentally be any color. However, the color of an outer skin of the vehicle is preferred. The chrome layer can be designed as a chrome foil. Therefore, overall a preferred construction is specified for the visible element and/or the decorative region.

According to a further idea of the invention, expediently a radiator grille for a vehicle, in particular a vehicle designed for semi-autonomous driving, is provided, which is equipped with at least one component designed according to the preceding description.

In summary, the present invention expediently relates to a component for a vehicle, having a visible element, which has a decorative region. It is essential that the decorative region is designed to be at least partially permeable for radar rays and light rays. The component also has a carrier element designed to be at least partially permeable for radar rays and light rays, having a heating element designed to be at least partially permeable for radar rays and light rays, for heating the decorative region, a light guide device designed to be at least partially permeable for radar rays and light rays, for illuminating the decorative region, and a radar camera for traffic monitoring, which is set up to transmit radar rays. The invention furthermore relates to a radiator grille for a vehicle, which has at least one such component.

Further important features and advantages of the invention result from the dependent claims, the drawings and the associated figure description with reference to the drawings.

It is understood that the aforementioned features and the features still to be explained in the following can not only be used in the respectively specified combination, but also in other combinations or in isolation, without leaving the scope of the present invention.

Preferred exemplary embodiments of the invention are represented in the drawings and are explained in more detail in the following description, wherein the same reference signs refer to identical or similar or functionally identical components.

### BRIEF SUMMARY OF THE DRAWING FIGURES

The drawings show, in each case schematically:

FIG. 1 in a very simplified perspective view, a vehicle having a radiator grille according to the invention,

FIG. 2 a similarly very simplified sectional view through a component according to the invention, which can be installed in the radiator grille according to FIG. 1, and

FIG. 3 in a similarly very simplified sectional view, an assembly which can be used as an insert in the production of the component according to the invention.

### DETAILED DESCRIPTION

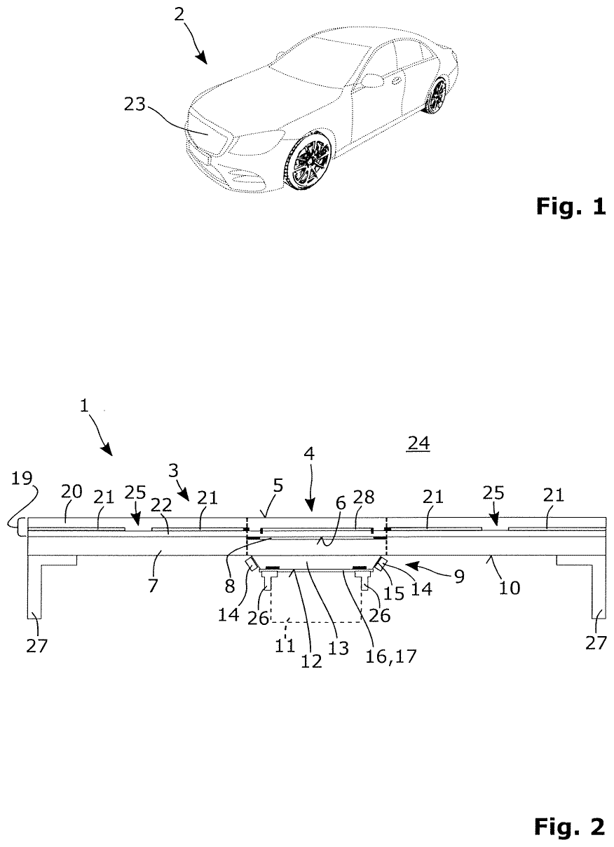

FIG. 1 shows, as explained, in a very simplified perspective view, an exemplary vehicle, labelled in its entirety with the reference sign 2, having a radiator grille 23, which has at least one component 1 according to the invention or is formed from the same.

FIG. 2 shows in a very simplified sectional view, a component 1 according to the invention, which can be attached to a chassis of the vehicle 2, not shown, using for example a frame 27. It has a visible element, labelled in its entirety with 3, which has a decorative region 4 that is designed to be at least partially permeable for radar rays and light rays, is indicated by dashed vertical lines in FIG. 2, and has a visible side 5 facing towards the surroundings 24 and a back side 6 facing away from the visible side 5. The decorative region 4 can be equipped with a decorative design 28 visible from the surroundings 24 or form such a decorative design. Furthermore, it can be seen in FIG. 2 that the visible element 2 and/or the decorative region 4 has a flat layer arrangement 19 or is formed by such. The layer arrangement 19 has a flat outer layer 20, made for example from a polyurethane coating (abbr. PU), having or forming the visible side 5, a flat lacquer layer 21 arranged on the same and a flat chrome layer 22 arranged on the lacquer layer 21. Lastly, the back side 6 can have or form the decorative region 4. Furthermore, the chrome layer 22 has open regions with further decorative designs 25. The chrome layer 22 can be realized by a chrome foil.

It is essential that the component 1 has a carrier element 7 designed to be at least partially permeable for radar rays and light rays, which is arranged on the back side 6 of the decorative region 4 and has a heating element 8 designed to be at least partially permeable for radar rays and light rays for heating the decorative region 4. In the present case, the heating element 8 is realized by a heating foil and is directly arranged on the back side 6 of the decorative region 4, wherein in this region a white print is also or can also be applied to the rear of the chrome layer 22.

Furthermore, it can be seen in FIG. 2 that the component 1 has a light guide device 9 designed to be at least partially permeable for radar rays and light rays for illuminating the decorative region 4, which light guide device is arranged, for example, opposite the heating element 8 on a carrier back side 10 of the carrier element 7, facing away from the decorative region 4, and is set up to transmit light rays to the decorative region 4. Furthermore, it is provided that the component 1 has a radar camera 11 for traffic monitoring and in particular for distance measurement, which is arranged on a back side 12 of the light guide device 9 facing away from the carrier element 7 via a sealing frame and camera holder 26 attached there and is set up to transmit radar rays to the decorative region 4. The decorative region 4 of the visible element 3 can be heated using the heating element 8, so that during operation of the vehicle 2 any condensation fogging, for example icing or moisture condensation, on the visible side 5 of the decorative region 4 can be prevented or eliminated. The heating element 8 and the light guide device 9 are matched to the radar camera 11 in such a way that interference with the radar camera 11 is prevented. This has the advantage that light rays and radar rays can permeate the decorative region 4 unhindered even in difficult weather conditions, so that the component 1 according to the invention can be reliably operated.

Furthermore, the light guide device 9 and the carrier element 7 are designed so that they form a cover for the radar camera 11. Therefore, the radar camera 11 can be protected from damaging environmental influences, such as moisture or solar radiation. Furthermore, it can be seen in FIG. 2 that the light guide device 9 has a central light guide element 13 designed to be permeable for radar rays and light rays and a light guide element 14 for guiding light rays from a light source (not illustrated here) to the central light guide element 13. In the present case, the light guide element 14 has a ring-shaped design and enables lateral coupling of light rays into the light guide device 9, which enables a relatively compact design of the component 1.

In FIG. 2 it can also be seen that the ring-shaped light guide element 14 is supported on a polished light coupling-in surface 15 of the central light guide element 13 for coupling light rays into the central light guide element 13. In the present case, the polished light coupling-in surface 15 of the central light guide element 13 is designed in the form of a funnel, wherein an imaginary funnel tip points to the radar camera 11. Furthermore, it should be mentioned that the radar camera 11 has a diaphragm 16 having a diaphragm opening 17 facing towards the decorative region 4. A reflective foil with white print can be provided on the diaphragm 16. The radar camera 11 is designed so that the radar rays provided by it permeate through the diaphragm opening 17 to the decorative region 4. In order to prevent undesired influencing of the radar rays by the light guide device 9, in the present case it is provided that the ring-shaped light guide element 14 and the diaphragm opening 17 are arranged coaxially or concentrically with respect to each other and the light guide element 14 has an inner diameter which is equal to or greater than a diaphragm diameter of the diaphragm opening 17. Therefore, it is ensured that the ring-shaped light guide element 14 does not cover the diaphragm opening 17.

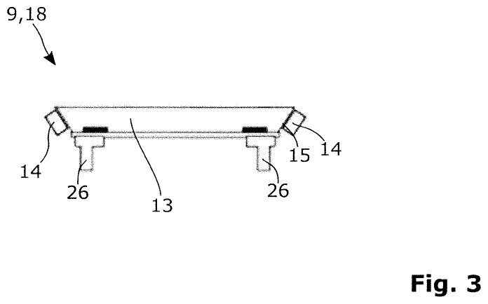

According to FIG. 3, a prefabricated assembly 18 can be seen, which is formed by the light guide device 9 or by the light guide element 14 of the light guide device 9 and the central light guide element 13 of the light guide device 9. The assembly 18 represents an intermediate product, which is prefabricated and then can be used as an insert in the production of the component 1. For example, the prefabricated assembly 18 can be fixed to the carrier element 7, in particular in an injection molding process, during production of the component 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A vehicle component, the vehicle component comprising:
a visible element having a decorative region, wherein the decorative region has a visible side and a back side facing away from the visible side, and wherein the decorative region is at least partially permeable to radar rays and light rays;
a carrier element, at least partially permeable to the radar rays and the light rays, is arranged on the back side of the decorative region and has a heating element that is at least partially permeable to the radar rays and the light rays and configured to heat the decorative region;
a light guide device, at least partially permeable to the radar rays and the light rays, configured to illuminate the decorative region, wherein the light guide device is arranged on a carrier back side of the carrier element, facing away from the decorative region, and is configured to transmit the light rays to the decorative region; and
a radar camera configured to monitor traffic arranged on a back side of the light guide device, facing away from the carrier element, and configured to transmit the radar rays to the decorative region,
wherein
the light guide device has a central light guide element that is at least partially permeable to the radar rays and the light rays and a light guide element configured to guide the light rays from a light source to the central light guide element,
the light guide element is ring-shaped,
the radar camera has a diaphragm having a diaphragm opening facing towards the decorative region and the radar camera transmits the radar rays to the decorative region through the diaphragm opening, and
the ring-shaped light guide element has an inner diameter equal to or greater than a diaphragm diameter of the diaphragm opening, or
wherein
the light guide device has a central light guide element that is permeable to the radar rays and the light rays and a light guide element configured to guide the light rays from a light source to the central light guide element,
the light guide element is ring-shaped,
the light guide element is supported on a light coupling-in surface of the central light guide element, the light coupling-in surface configured to couple the light rays into the central light guide element, and
the light coupling-in surface of the central light guide element tapers in a form of a funnel towards the decorative region or towards the radar camera.

8. The vehicle component of claim 7, wherein the light guide device or the carrier element form a cover for the radar camera.

9. The vehicle component of claim 7, wherein the light guide device or the light guide element of the light guide device and a central light guide element of the light guide device form a prefabricated assembly, wherein the prefabricated assembly is usable as an insert as an intermediate product when producing the vehicle component and is fixable on the carrier element.

10. The vehicle component of claim 6, wherein the heating element is a heating foil.

11. The vehicle component of claim 10, wherein the heating foil is electrically operable.

12. The vehicle component of claim 10, wherein the heating element is arranged on the back side of the decorative region.

13. The vehicle component of claim 7, wherein the visible element or the decorative region has or forms a flat layer arrangement, wherein the flat layer arrangement has a flat outer layer having or forming a visible side, a flat lacquer layer arranged on the flat outer layer, and a flat chrome layer arranged on the lacquer layer, wherein the flat chrome layer has or forms the back side of the decorative region.

14. A vehicle radiator grille comprising:
a vehicle component, which comprises
a visible element having a decorative region, wherein the decorative region has a visible side and a back side facing away from the visible side, and wherein the decorative region is at least partially permeable to radar rays and light rays;
a carrier element, at least partially permeable to the radar rays and the light rays, is arranged on the back side of the decorative region and has a heating element that is at least partially permeable to the radar rays and the light rays and configured to heat the decorative region;
a light guide device, at least partially permeable to the radar rays and the light rays, configured to illuminate the decorative region, wherein the light guide device is arranged on a carrier back side of the carrier element, facing away from the decorative region, and is configured to transmit the light rays to the decorative region; and
a radar camera configured to monitor traffic arranged on a back side of the light guide device, facing away from the carrier element, and configured to transmit the radar rays to the decorative region,
wherein
the light guide device has a central light guide element that is at least partially permeable to the radar rays and the light rays and a light guide element configured to guide the light rays from a light source to the central light guide element,
the light guide element is ring-shaped,
the radar camera has a diaphragm having a diaphragm opening facing towards the decorative region and the radar camera transmits the radar rays to the decorative region through the diaphragm opening, and
the ring-shaped light guide element has an inner diameter equal to or greater than a diaphragm diameter of the diaphragm opening, or
wherein
the light guide device has a central light guide element that is permeable to the radar rays and the light rays and a light guide element configured to guide the light rays from a light source to the central light guide element,
the light guide element is ring-shaped,
the light guide element is supported on a light coupling-in surface of the central light guide element, the light coupling-in surface configured to couple the light rays into the central light guide element, and
the light coupling-in surface of the central light guide element tapers in a form of a funnel towards the decorative region or towards the radar camera, and
wherein the vehicle is a semi-autonomous driving vehicle.
